(19) United States
(12) Patent Application Publication
(10) Pub. No.: US 2012/0217754 A1
(43) Pub. Date: Aug. 30, 2012

(54) WIND TURBINE BLADE, WIND TURBINE GENERATOR WITH THE SAME, AND DESIGN METHOD OF WIND TURBINE BLADE

(75) Inventor: Koji FUKAMI, Tokyo (JP)

(73) Assignee: MITSUBISHI HEAVY INDUSTRIES, LTD., Tokyo (JP)

(21) Appl. No.: 13/459,324

(22) Filed: Apr. 30, 2012

Related U.S. Application Data
(63) Continuation of application No. PCT/JP2012/053713, filed on Feb. 16, 2012.

(30) Foreign Application Priority Data
Feb. 28, 2011 (JP) 2011-043188

(51) Int. Cl. F03D 9/00; G06F 17/50; F03D 1/06

(52) U.S. Cl. 290/55; 416/235; 703/1

(57) ABSTRACT

Provided is a wind turbine blade realizing enhancement of performance by a winglet provided at a blade tip. The wind turbine blade includes the winglet formed by bending a tip side thereof toward a pressure side of the blade relative to an adjacent portion adjacent on a blade root side, and a CANT angle defined by a blade axial line of the winglet relative to a radial extrapolation line of a blade axial line of the adjacent portion is set to be 15° or more and 55° or less. The winglet includes a tip end located on a tip side thereof, having a substantially linear blade axial line, and a bent portion located on a base end side of the winglet and bent relative to the adjacent portion. This bent portion is bent gradually so as to satisfy the predetermined CANT angle.

### CROSS-REFERENCE TO RELATED APPLICATIONS

This application is based on Japanese Patent Application No. 2011-043188, the contents of which are incorporated herein by reference.

### TECHNICAL FIELD

The present invention relates to a wind turbine blade, a wind turbine generator with the same, and a design method of a wind turbine blade.

### BACKGROUND ART

Recently, a wind turbine generator has attracted people's attention as clean energy that does not emit greenhouse effect gas when generating power. A wind turbine generator rotates wind turbine blades around its axis by wind and converts this rotation force into electric power so as to attain power output.

Power output of a wind turbine generator is expressed by a product of shaft end output (output generated by blades) and conversion efficiency (efficiencies of bearings and a generator, and the like). The shaft end output is expressed by the following formula, and a blade having high blade efficiency and a greater diameter enhances electric power generation.

Shaft end output=½×Air density×Wind speed̂3×Blade efficiency×π×(Blade diameter/2)̂2

Blade efficiency has a logical upper limit (Betz limit=0.593). Actually, the upper limit of blade efficiency is approximately 0.5 because of (1) efficiency loss due to swirl (rotation) of a blade wake, (2) efficiency loss due to air resistance on a blade section, and (3) efficiency loss due to a wing tip vortex. In the above (1), the loss can be reduced by setting the rotational torque to be smaller according to the law of conservation of angular momentum (i.e. by accelerating the rotational frequency). On the other hand, in the above (2), as the rotational frequency becomes higher, the loss due to air resistance tends to become greater. Therefore, there is a conflict relationship between the above (1) and the above (2), and it is difficult to cope with both.

However, the above (3) can be improved by modifying the blade tip shape, so as to enhance the efficiency.

The following Patent Literature 1 discloses an improved blade tip shape. Specifically, a wind tip is so bent toward a pressure side of the blade in the angle range from 70° to 90° (CANT angle) as to form a winglet.

### CITATION LIST

### Patent Literature

### {PTL 1}

U.S. Pat. No. 7,540,716 (Column 5, lines 25-37, and FIG. 6)

### SUMMARY OF INVENTION

### Technical Problem

Unfortunately, Patent Literature 1 specifies the CANT angle in the light of noise reduction, but not in the light of reduction of efficiency loss due to wing tip vortex as explained in the above (3), that is, not in the light of improvement of the performance.

In addition, when designing a wind turbine blade, a moment caused on a blade root of a wind turbine blade should be taken into account in the light of not only the performance of a wind turbine blade but also the reliability on a whole wind turbine. In Patent Literature 1, however, the moment caused on the blade root of the wind turbine blade is not reviewed.

The present invention has been made in the light of the above facts, and has an object to provide a wind turbine blade, a wind turbine generator with the same and a design method of a wind turbine blade capable of realizing enhancement of performance by a winglet formed at a wing tip.

The present invention also has an object to provide a wind turbine blade, a wind turbine generator with the same and a design method of a wind turbine blade capable of reducing moment (load) caused on a blade root of a wind turbine blade.

### Solution to Problem

In order to solve the above problems, the wind turbine blade, the wind turbine generator with the same and the design method of the wind turbine blade of the present invention employs the following solutions.

A wind turbine blade according to a first aspect of the present invention includes a winglet formed by bending a tip side thereof toward a suction side of the blade or a pressure side of the blade relative to an adjacent portion adjacent on a blade root side, and the wind turbine blade has a CANT angle of 15° or more and 55° or less, in which the CANT angle is defined by a blade axial line of the winglet relative to a radial extrapolation line of a blade axial line of the adjacent portion.

The CANT angle of the winglet is configured to be 15° or more and 55° or less so that swirls on the blade tip are reduced, thereby enhancing the performance (torque generated by the wind turbine blade) and/or reducing the moment on the blade root.

According to the simulations made by the inventors of the present invention, the performance is enhanced by about 0.3% at most, and the blade root moment is reduced by 0.45% at most.

Each of the blade axial lines is defined, for example, as a line formed by connecting in the blade axial direction each maximum blade thickness position on a center line of each of blade sections (a line from a leading edge to a trailing edge through a point located at an equivalent distance to the suction side surface of the blade and to the pressure side surface of the blade) in the radial position. A chord of blade may be used instead of the center line.

The CANT angle is preferably set to be 25° or more and 35° or less.

The wind turbine blade according to the first aspect of the present invention includes a tip end located on a tip side thereof, having a substantially linear blade axial line; and a bent portion located on a base end side thereof and bent relative to the adjacent portion, and the bent portion is bent gradually so as to satisfy the CANT angle.

The bent portion is configured to be bent gradually so as to satisfy the CANT angle. Specifically, the winglet is formed to be bent not sharply but smoothly and continuously relative to the adjacent portion. Accordingly, it is possible to prevent great bending stress from being caused onto the bent portion.

In the wind turbine blade according to the first aspect of the present invention, a CANT position that is a start position where the winglet is started to be bent relative to the adjacent portion is set to be 97.0% R or more and 98.5% R or less, where a blade diameter is set to be R when the CANT angle of the winglet is 0.

The CANT position is configured to be 97.0% R or more and 98.5% R or less, thereby enhancing the performance of the wind turbine blade and/or reducing the blade root moment.

In the wind turbine blade according to the first aspect of the present invention, the winglet is bent toward a pressure side of the blade when the wind turbine blade is located on an up-wind side of a wind turbine tower.

In the case of an up-wind wind turbine in which the wind turbine blade is located on the up-wind side of the wind turbine tower, the winglet is configured to be bent toward the pressure side of the blade. Therefore, the tip of the winglet is disposed apart from the wind turbine tower, so that the winglet can be prevented from coming into contact with the wind turbine tower, thereby enhancing the safety. Further, it is also possible to reduce noise caused by aerodynamic interference against the wind turbine tower, and variable load caused on the wind turbine blade and the wind turbine tower, thereby realizing noise reduction and load reduction.

In the wind turbine blade according to the first aspect of the present invention, the winglet is bent toward a suction side of the blade when the wind turbine blade is located on a down-wind side of a wind turbine tower.

In the case of the down-wind wind turbine in which the wind turbine blade is located on the down-wind side of the wind turbine tower, the winglet is configured to be bent toward the suction side of the blade. Accordingly, the tip of the winglet is disposed apart from the wind turbine tower, so that the winglet can be prevented from coming into contact with the wind turbine tower, thereby enhancing the safety. Further, since the wind turbine blade is configured to be used in a down-wind wind turbine, the weather vane effect (tracking performance to the wind direction) can be enhanced so as to reduce load caused on the wind turbine blade and the wind turbine tower.

The wind turbine generator according to a second aspect of the present invention includes any one of the above described turbine blades, a rotor connected to a blade root side of the wind turbine blade and being rotated by the wind turbine blade, and a generator for converting rotation force obtained by the rotor into electric output.

The wind turbine generator is provided with the above described wind turbine blade, so that it is possible to enhance the performance and/or reduce the blade root moment of the wind turbine blade, thereby realizing enhancement of the power output and/or enhancement of the reliability.

A design method of a wind turbine blade according to a third aspect of the present invention is provided with a winglet whose tip side is bent toward a suction side of the blade or a pressure side of the blade relative to an adjacent portion adjacent on a blade root side, wherein the design method configures the winglet to have a greater blade diameter than a CANT position that is a start position where the winglet is started to be bent relative to the adjacent portion, and determines a CANT angle so as to enhance torque generated by the wind turbine blade and decrease moment caused on the blade root of the wind turbine blade, compared to a reference blade having the CANT angle of 0, in which the CANT angle is defined by a blade axial line of the winglet relative to a radial extrapolation line of a blade axial line of the adjacent portion.

If the performance is evaluated for the reference blade having the blade diameter equal to the CANT position, it is obvious that the performance is enhanced since a winglet is added to the reference blade so that the blade diameter becomes increased. In such a method, the effect achieved by the winglet cannot be accurately evaluated. Therefore, the present embodiment specifies the CANT angle at which the torque (i.e. performance) becomes increased and the blade root moment becomes decreased not relative to the reference blade having the blade diameter equal to the CANT position, but relative to the reference blade having the greater blade diameter than the CANT position. Accordingly, it is possible to accurately evaluate the effect by the winglet, and determine the appropriate CANT angle.

As the blade diameter of the reference blade that is a greater blade diameter than the CANT position, a blade diameter R when the CANT angle of the winglet is 0 and/or a blade diameter that is a median between the blade diameter R and the CANT position may be used.

### Advantageous Effects of Invention

According to the present invention, the CANT angle of the winglet is configured to be 15° or more and 55° or less, so that swirls on the blade tip are reduced, thereby enhancing the performance (torque generated by the wind turbine blade) and/or reducing the moment (load) caused on the blade root.

### BRIEF DESCRIPTION OF DRAWINGS

FIG. 1 illustrates a winglet of a wind turbine blade according to one embodiment of the present invention, and is a front view seen from a blade leading edge.

FIG. 2 illustrates various tips of the wind turbine blade that were used in the studies in the present embodiment.

FIG. 3 shows a graph of the results of simulation made on each of the wind turbine blades illustrated in FIG. 2.

FIG. 4 shows a graph of the results of FIG. 3 by focusing on the torques (performance).

FIG. 5 shows a graph of the results of FIG. 3 by focusing on the load (blade root moment).

### DESCRIPTION OF EMBODIMENT

Hereinafter, descriptions will be provided on the embodiment according to the present invention with reference to the drawings.

The wind turbine blades according to the present embodiment are preferably used as blades of a wind turbine generator. The wind turbine blades are configured to be three dimensional blades and include three blades, for example, which are respectively coupled to a rotor at 120° intervals. Each wind turbine blade preferably has a rotational diameter (blade diameter) of 60 m or more, and is a slender blade whose solidity is 0.2 or more and 0.6 or less. The wind turbine blade may have a variable pitch or a fixed pitch.

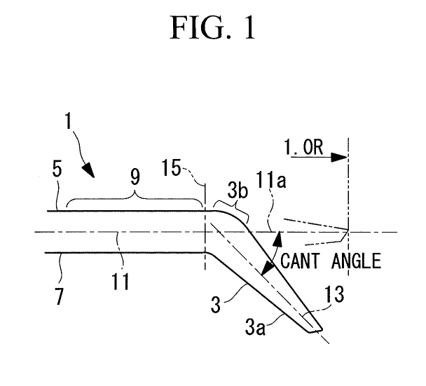

FIG. 1 illustrates a tip of the wind turbine blade 1 provided with a winglet 3. This drawing is a front view of the wind turbine blade viewed from the leading edge thereof, and a suction side of the blade (suction surface) 5 is located on the upper side and a pressure side of the blade (static pressure surface) 7 is located on the lower side in this drawing.

As illustrated in the same drawing, the winglet 3 is formed to be bent toward the pressure side of the blade relative to an adjacent portion 9 adjacent on the blade root side. The present embodiment assumes an up-wind wind turbine having the wind turbine blade 1 located on the up-wind side of the wind turbine tower so that the winglet 3 is bent toward the pressure side of the blade, but may be bent toward the suction side of the blade. In the case of a down-wind wind turbine, the winglet 3 is preferably bent toward the suction side of the blade.

The CANT angle is an angle defined by a blade axial line 13 of the winglet 3 relative to a radial extrapolation line 11a of a blade axial line 11 of the adjacent portion 9. Each of the blade axial lines 11, 13 is defined, for example, as a line formed by connecting in the blade axial direction each maximum blade thickness position on a center line of each of the blade sections (a line from a leading edge to a trailing edge through a point located at an equivalent distance to the suction side surface of the blade and to the pressure side surface of the blade) in the radial position. A chord of blade may be used instead of the center line.

In the present embodiment, the CANT angle is set to be 15° or more and 55° or less, preferably 25° or more and 35° or less, as described later.

The winglet 3 includes a tip end 3a located on its tip side thereof and having a substantially linear blade axial line 13, and a bent portion 3b located on its base end side and bent relative to the adjacent portion. The bent portion 3b is configured to have a gradually bent shape so as to satisfy the desired CANT angle. Specifically, the bent portion 3b has a continuous curved face having a radius of curvature of a predetermined value or more so as to be smoothly connected to the tip end 3a having the linear blade axial line 13.

The CANT position 15 that is a start position where the winglet 3 is started to be bent relative to the adjacent portion 9 is set to be 1.5% R or more and 3.0% R or less, where the blade diameter is set to be 1.0 R when the CANT angle of the winglet 3 is 0.

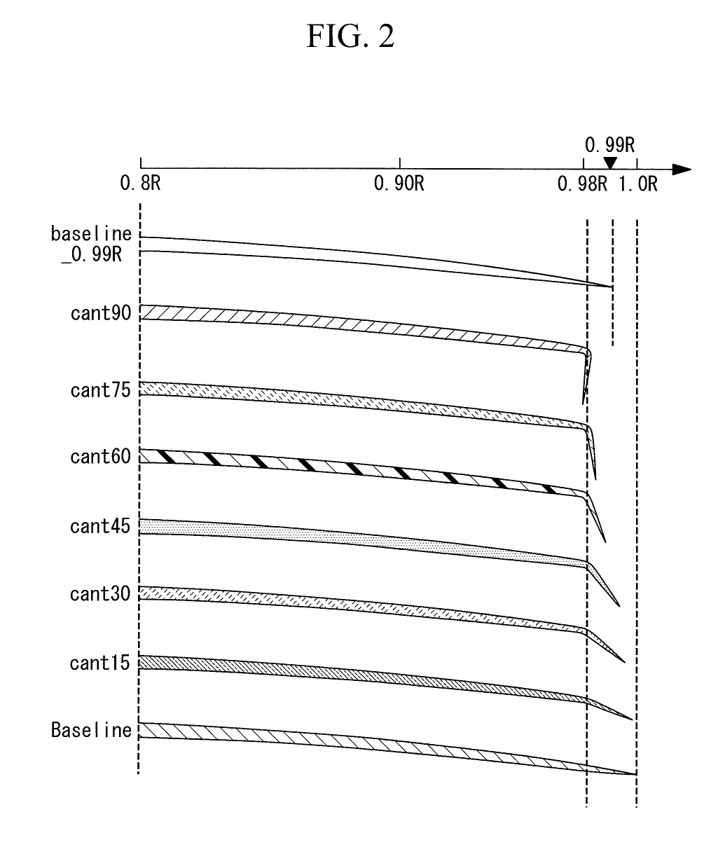

FIG. 2 illustrates various tips of the wind turbine blade that were used in the studies on the wind turbine blade of the present embodiment. Specifically, various tips of the wind turbine blade are illustrated in the range of 0.8 R to 1.0 R, where the wind turbine blade with no winglet (i.e. the CANT angle is 0) is set to be 1.0 R.

In the same figure, the following tips of the wind turbine blade are illustrated in order from the top to the bottom of the drawing.

baseline_{—}0.99R; a tip of the wind turbine blade as the reference blade for comparison, having a blade diameter of 0.99R with no winglet.

cant90; a tip of the wind turbine blade bent at the CANT position of 0.98R, having the CANT angle of 90°.

cant75; a tip of the wind turbine blade bent at the CANT position of 0.98R, having the CANT angle of 75°.

cant60; a tip of the wind turbine blade bent at the CANT position of 0.98R, having the CANT angle of 60°.

cant45; a tip of the wind turbine blade bent at the CANT position of 0.98R, having the CANT angle of 45°.

cant30; a tip of the wind turbine blade bent at the CANT position of 0.98R, having the CANT angle of 30°.

cant15; a tip of the wind turbine blade bent at the CANT position of 0.98R, having the CANT angle of 15°.

baseline; a tip of the wind turbine blade as the reference blade for comparison, having a blade diameter of 1.0 R with no winglet.

As described above, the baseline_{—}0.99R and the baseline that are the reference blades have greater diameters than 0.98R that is the CANT position. The baseline_{—}0.99R that is one of the reference blades has a blade diameter that is a median between the 0.98R of the CANT position and 1.0R of the baseline.

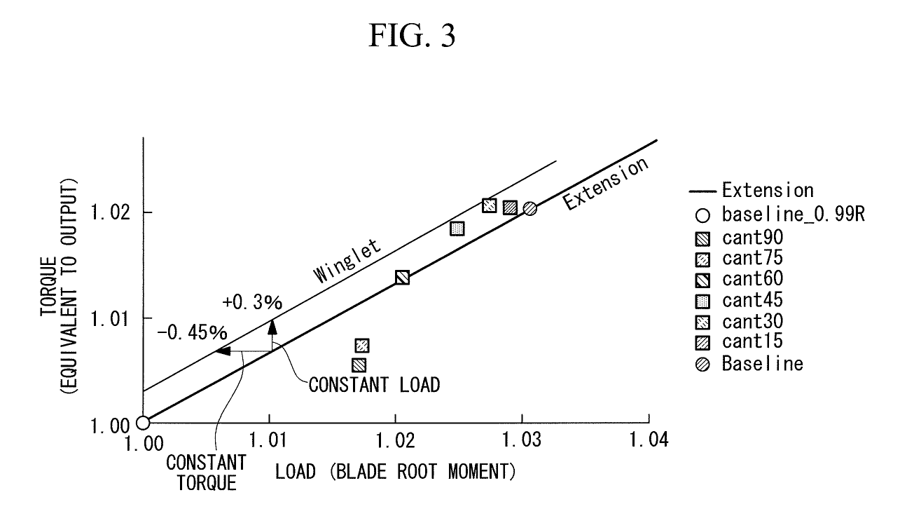

With respect to each of the wind turbine blades illustrated in FIG. 2, the torque (equivalent to output) and the load (moment caused on the blade root; blade root moment) that are generated by each wind turbine blade are calculated by simulations, and calculated results are shown in FIG. 3.

In the simulations used in the studies of the present embodiment, the design tip speed ratio is set to be 8.0 or more and 8.5 or less, and the Reynolds number is set to be 3,000,000 or more and 10,000,000 or less. Note that the design tip speed ratio is found by “blade tip speed/infinite up-wind speed”. The Reynolds number in the wind turbine is obtained by taking account of a relative wind speed with respect to a predetermined cross section of a blade rotating at a predetermined rotational frequency, and is expressed by the following formula.

Reynolds number=Air density×Relative wind speed with respect to blade section×Code length of blade section/Viscosity coefficient of air

In FIG. 3, the vertical axis denotes the torque (equivalent to output), and a greater value indicates that the wind turbine blade has a higher performance. The horizontal axis denotes the load, and a smaller value indicates a smaller blade root moment which means that the wind turbine has a longer durability life.

In the same figure, the value of the baseline_{—}0.99 was used as the origin (1.0, 1.0) at the lower left. A straight line (Extension) passing through this origin and the value of the baseline was drawn. If a value falls above the straight line (Extension), it means that the torque is greater and the load is smaller, and if a value falls below the line, it means that the torque is smaller and the load is greater. In other words, the region above the straight line (Extension) exhibits the effect achieved by the winglet. As apparent in the same figure, the CANT angles 75° and 90° fall in the region below the straight line (Extension), and this indicates that the effect by the winglet cannot be attained. The CANT angle 60° falls on the straight line (Extension), and this indicates that the effect by the winglet scarcely exhibits.

To the contrary, the CANT angles 45°, 30° and 15° fall in the region above the straight line (Extension), and this indicates that the torque is enhanced and the load is reduced, which means the effect by the winglet can be attained. As described above, an appropriate setting of the CANT angle of the winglet allows the value to fall on the straight line (Winglet). Considering on the straight line (Winglet), if the CANT angle is so set as to increase the torque (performance) using the constant load, the performance is increased by 0.3%, and if the CANT angle is so set as to decrease the load using the constant performance, the load is decreased by 0.45%.

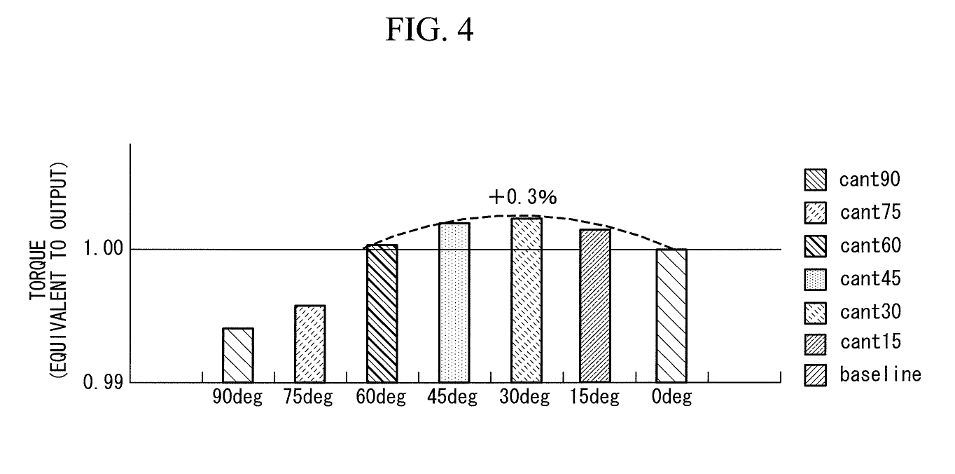

FIG. 4 shows a graph of the results of FIG. 3 by focusing on the torques (performance) generated by the various wind turbine blades. As apparent in the same graph, the torque becomes greater at the CANT angle of 15° or more, and the torque also becomes increased at 55° or less which is less than 60°. To the contrary, the torque is rather decreased at the CANT angle of 70° to 90° which is disclosed in Patent Literature 1.

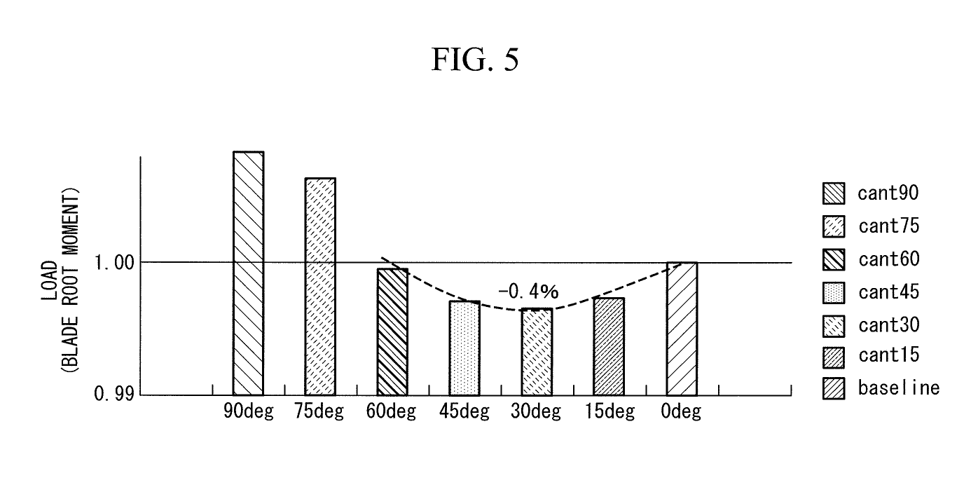

FIG. 5 shows a graph of the results of FIG. 3 by focusing on the loads (blade root moment). As apparent in the same graph, the load becomes smaller at the CANT angle of 15° or more, and the load also is decreased at 55° or less which is less than 60°. To the contrary, the load is rather increased at the CANT angle of 70° to 90° which is disclosed in Patent Literature 1.

As illustrated in FIG. 3, the design method of the wind turbine blade to determine the CANT angle of the winglet in accordance with the graph expressed by one axis having the torque (performance) and the other axis having the load (blade root moment) provides the following advantages.

If the performance is evaluated for the reference blade having the blade diameter equal to the CANT position (i.e. wind turbine blade having the blade diameter of 0.98R), it is obvious that the performance is enhanced since a winglet is added to the reference blade of 0.98R so that the blade diameter becomes increased. In such a method, the effect achieved by the winglet cannot be accurately evaluated.

Therefore, the present embodiment does not employ the reference blade having a blade diameter of 0.98R which is equal to the CANT position, but employs the reference blade “baseline 0.98” having the blade diameter of 0.99R and the reference blade “baseline” having the blade diameter of 1.0R, both of which are a greater blade diameter than the CANT position, so as to specify the range that exhibits effect with respect to the torque and the load, and set the CANT angle at which the torque (performance) becomes increased and the blade root moment becomes decreased. Accordingly, it is possible to accurately evaluate the effect by the winglet, and determine the appropriate CANT angle.

Although the present embodiment employs two reference blades (baseline 0.98R and baseline) for the evaluation, if the straight line (Extension) illustrated in FIG. 3 can be specified by using other design standards, only one reference blade having a greater blade diameter than the CANT position may be used for the evaluation.

As described above, according to the present embodiment, the following operation and effect can be attained.

The CANT angle of the winglet 3 is configured to be 15° or more and 55° or less (preferably 25° or more and 35° or less), so that swirls on the blade tip are reduced, thereby enhancing the performance (torque generated by the wind turbine blade) and/or reducing the load (blade root moment).

According to the simulations made by the inventors of the present invention, the performance is enhanced by 0.3% at most, and the blade root moment is reduced by 0.45% at most.

The bent portion 3b is configured to be so bent gradually as to satisfy the desired CANT angle. Specifically, the winglet 3 is formed to be bent not sharply but smoothly and continuously relative to the adjacent portion 9. Accordingly, it is possible to prevent great bending stress from being caused onto the bent portion 3b.

In the case of an up-wind wind turbine in which the wind turbine blade 1 is located on the up-wind side of the wind turbine tower, the winglet 3 is configured to be bent toward the pressure side of the blade, so that the tip of the winglet 3 is disposed apart from the wind turbine tower, therefore, the winglet 3 can be prevented from coming into contact with the wind turbine tower, thereby enhancing the safety. Further, it is also possible to reduce noise caused by aerodynamic interference against the wind turbine tower, and variable load caused on the wind turbine blade and the wind turbine tower, thereby realizing noise reduction and load reduction. Of course, if there is no possibility of interference against the wind turbine tower or the like, the winglet 3 may be bent toward the suction side of the blade.

In the case of a down-wind wind turbine in which the wind turbine blade is located on the down-wind side of the wind turbine tower, the winglet is preferably configured to be bent toward the suction side of the blade. Accordingly, the tip of the winglet is disposed apart from the wind turbine tower, so that the winglet can be prevented from coming into contact with the wind turbine tower, thereby enhancing the safety. Further, since the wind turbine blade is configured to be used in a down-wind wind turbine, the weather vane effect (tracking performance to the wind direction) can be enhanced so as to reduce load caused on the wind turbine blade and the wind turbine tower. Of course if there is no possibility of interference against the wind turbine tower or the like, the winglet may be bent toward the pressure side of the blade.

The wind turbine generator according to the present embodiment is provided with the wind turbine blade 1 of the present embodiment, so that it is possible to enhance the performance and/or reduce the blade root moment of the wind turbine blade, thereby realizing enhancement of the power output and/or enhancement of the reliability.

In the present embodiment, the studies have been made on the simulation results based on the CANT position of 0.98R (98% R), however, the CANT position of 97.0% R or more and 98.5% R or less can also achieve the same advantageous effects.

1. A wind turbine blade comprising a winglet formed by bending a tip side thereof toward a suction side of the blade or a pressure side of the blade relative to an adjacent portion adjacent on a blade root side,
the wind turbine blade having a CANT angle of 15° or more and 55° or less, the CANT angle defined by a blade axial line of the winglet relative to a radial extrapolation line of a blade axial line of the adjacent portion.

2. The wind turbine blade according to claim 1, wherein
the winglet comprises:
a tip end located on a tip side thereof, having a substantially linear blade axial line; and
a bent portion located on a base end side thereof and bent relative to the adjacent portion,
and
the bent portion is bent gradually so as to satisfy the CANT angle.

3. The wind turbine blade according to claim 1, wherein
a CANT position that is a start position where the winglet is started to be bent relative to the adjacent portion is set to be 97.0% R or more and 98.5% R or less, where a blade diameter is set to be R when the CANT angle of the winglet is 0.

4. The wind turbine blade according to claim 1, wherein
the winglet is bent toward a pressure side of the blade when the wind turbine blade is located on an up-wind side of a wind turbine tower.

5. The wind turbine blade according to claim 1, wherein
the winglet is bent toward a suction side of the blade when the wind turbine blade is located on a down-wind side of a wind turbine tower.

6. A wind turbine generator comprising:
the wind turbine blade according to claim 1;
a rotor connected to a blade root side of the wind turbine blade and being rotated by the wind turbine blade; and
a generator for converting rotation force obtained by the rotor into electric output.

7. A design method of a wind turbine blade provided with a winglet whose tip side is bent toward a suction side of the blade or a pressure side of the blade relative to an adjacent portion adjacent on a blade root side,
the design method comprising:
configuring the winglet to have a greater blade diameter than a CANT position that is a start position where the winglet is started to be bent relative to the adjacent portion; and
determining a CANT angle so as to enhance torque generated by the wind turbine blade and decrease moment caused on the blade root of the wind turbine blade, compared to a reference blade having the CANT angle of 0,
the CANT angle being defined by a blade axial line of the winglet relative to a radial extrapolation line of a blade axial line of the adjacent portion.
